(19) United States
(12) Patent Application Publication
(10) Pub. No.: US 2009/0127732 A1
(43) Pub. Date: May 21, 2009

(54) METHOD OF COMPRESSION-MOLDING ELECTRONIC COMPONENTS AND MOLD

(76) Inventor: Takashi TAMURA, Kyoto-shi (JP)

Correspondence Address: BIRCH STEWART KOLASCH & BIRCH, PO BOX 747, FALLS CHURCH, VA, 22040-0747, US

(21) Appl. No.: 12/270,696

(22) Filed: Nov. 13, 2008

(30) Foreign Application Priority Data
Nov. 16, 2007 (JP) 2007-297846 (P)

(51) Int. Cl. B29C 43/18

(52) U.S. Cl. 264/101; 425/405.1; 264/272.14

(57) ABSTRACT

An upper mold section and a lower mold section are closed with prescribed mold clamping pressure, for dipping sets of electronic components mounted on a substrate into a resin material melted in cavities. A pressurizing/driving portion pressurizes/drives a pressurizing member toward upper mold section with prescribed pressurizing/driving force, so that this pressurizing/driving force is transmitted to cavity side surface members through a first elastic member and a second elastic member and forward end surfaces of cavity side surface members come into contact with a surface of substrate. The pressurizing/driving force is transmitted to second elastic member, so that this pressurizing/driving force is uniformly transmitted to the respective ones of cavity bottom surface members and resin material heated and melted in respective cavities can be uniformly pressed.

This nonprovisional application is based on Japanese Patent Application No. 2007-297846 filed on Nov. 16, 2007 with the Japan Patent Office, the entire contents of which are hereby incorporated by reference.

### BACKGROUND OF THE INVENTION

1. Field of the Invention

The present invention relates to a method of compression-molding electronic components and a mold, and more particularly, it relates to a method of compression-molding electronic components for sealing electronic components mounted on a substrate by compression-molding a resin material and a mold employed therefor.

2. Description of the Background Art

In general, an electronic component such as an IC (integrated circuit) mounted on a substrate is compression-molded with a resin material in a mold for compression-molding an electronic component. In the mold comprising an upper mold section and a lower mold section, a prescribed quantity of granular resin material is first supplied into a cavity provided on the lower mold section and melted. On the other hand, the substrate is set on the upper mold section while directing the surface mounted with the electronic component downward.

Then, the upper and lower mold sections are so closed as to dip the electronic component mounted on the substrate into the resin material melted in the cavity, and prescribed pressure is applied to the melted resin material with a cavity bottom surface member forming the bottom surface of the cavity. After a lapse of a time necessary for curing the resin material, the upper and lower mold sections are so opened as to extract the substrate mounted with the electronic component sealed in a resin-molded body compression-molded into a shape corresponding to that of the cavity. Japanese Patent Laying-Open No. 2004-146556 is one of documents disclosing this type of technique.

On the other hand, a plurality of electronic components mounted on a single substrate are individually compression-molded in a prescribed number of resin-molded bodies in a mold for compression-molding electronic components. For example, the plurality of electronic components mounted on the single substrate are individually compression-molded in four resin-molded bodies, so that a prescribed number of electronic components are individually sealed and compression-molded in each of the four resin-molded bodies. In this case, a resin material heated and melted in the four cavities is individually pressurized by cavity bottom surface members.

### SUMMARY OF THE INVENTION

In the conventional compression molding method, however, the quantity of the resin material supplied into each cavity may be so dispersed that the same is excessively or insufficiently supplied. If the resin material supplied into each cavity is pressurized by the corresponding cavity bottom surface member in this state, the resin material melted in each cavity cannot be uniformly and individually pressurized with prescribed pressure.

This problem particularly easily arises when a plurality of cavities are provided on a single mold. This type of problem may also arise when a plurality of resin-molded bodies are compression-molded with respect to a single substrate or when a plurality of substrates each having a collectively formed resin-molded body are simultaneously compression-molded.

In order to solve this problem, a mold having a communication path provided between cavities for adjusting the quantity of a resin material supplied into the cavities may be so employed as to uniformize pressure (resin pressure) in the cavities. If the electronic components are compression-molded with this type of mold, however, the overall molded substrate tends to easily warp due to the resin material cured in the communication path. If the substrate warps, the molded substrate is easily dropped in a transportation step of transporting the molded substrate after the compression molding step. In a step of cutting/separating the molded substrate, the molded substrate cannot be excellently fixed. Therefore, the aforementioned problem cannot be solved with this type of mold.

The present invention has been proposed in order to solve the aforementioned problems, and an object thereof is to provide a method of compression-molding electronic components capable of uniformly and individually pressurizing a resin material heated/melted in a plurality of cavities of a mold for compression-molding electronic components with prescribed pressure. Another object of the present invention is to provide a mold used for such a method of compression-molding electronic components.

The method of compression-molding electronic components according to the present invention is employed for sealing electronic components by compression-molding a resin material with a prescribed mold, and comprises the following steps: A mold including an upper mold section and a lower mold section opposed to the upper mold section and provided with a plurality of cavities supplied with a resin material is prepared as the prescribed mold. A compression-molded body sealing the electronic components is formed by closing the upper mold section and the lower mold section thereby dipping the respective ones of a plurality of electronic components mounted on a substrate held on the upper mold section into the resin material heated and melted in the corresponding cavities while uniformly pressurizing and compressing the resin material melted in the respective ones of the plurality of cavities by resin pressing members provided on the respective ones of the bottom surfaces of the plurality of cavities. The substrate mounted with the electronic components sealed in the compression-molded body is extracted by opening the upper mold section and the lower mold section.

The step of forming the compression-molded body may include the step of uniformly pressurizing and compressing the resin material melted in the respective ones of the plurality of cavities by another resin pressing member from a surface of the substrate opposite to the surface mounted with the electronic components.

Preferably, the resin material melted in the respective ones of the plurality of cavities is uniformly pressurized and compressed by pressure transmitted through elastic members provided on the resin pressing members in the step of forming the compression-molded body.

Preferably, the method further comprises the steps of covering the plurality of cavities with a mold releasing film, supplying the resin material to the respective ones of the plurality of cavities covered with the mold releasing film and cutting off the space where the cavities are positioned from the outside air by sealing a clearance between the upper mold section and the lower mold section between the steps of preparing the mold and forming the compression-molded body, and compression molding is performed by decompressing the space, where the cavities are positioned, cut off from the outside air to a prescribed degree of vacuum in the step of forming the compression-molded body.

The mold according to the present invention is a mold for compression-molding electronic components for sealing electronic components by compression-molding a resin material with an upper mold section and a lower mold section, and the upper mold section includes a substrate supply portion for setting a substrate mounted with the electronic components. The lower mold section includes a plurality of cavities supplied with the resin material respectively and a resin pressing member pressurizing the resin material heated and melted in the cavities with prescribed pressure. The resin pressing member includes a uniform pressurizing portion uniformly pressurizing the resin material heated and melted in the respective ones of the plurality of cavities.

Preferably, the resin pressing member includes a cavity bottom surface member forming the bottom surfaces of the cavities, and the uniform pressurizing portion includes an elastic member transmitting the prescribed pressure to the cavity bottom surface member.

Preferably, the resin pressing member includes a cavity bottom surface member forming the bottom surfaces of the cavities, and the cavity bottom surface member is divided into a prescribed number.

According to the inventive method of compression-molding electronic components or the inventive mold, the resin material heated and melted in the plurality of cavities of the mold can be uniformly and individually pressurized with the prescribed pressure.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1(a) and 1(b) are sectional views showing an open state and a closed state of a mold for compression-molding electronic components according to a first embodiment of the present invention respectively;

FIGS. 2(a) and 2(b) are sectional views showing an open state and a closed state of a mold for compression-molding electronic components according to a second embodiment of the present invention respectively;

FIGS. 3(a) and 3(b) are sectional views showing an open state and a closed state of a mold for compression-molding electronic components according to a third embodiment of the present invention respectively; FIGS. 4(a) and 4(b) are sectional views showing an open state and a closed state of a mold for compression-molding electronic components according to a fourth embodiment of the present invention respectively;

FIGS. 5(a) and 5(b) are sectional views showing an open state and a closed state of a mold for compression-molding electronic components according to a fifth embodiment of the present invention respectively;

FIG. 6 is a sectional view showing an open state of a mold for compression-molding electronic components according to a sixth embodiment of the present invention; and

FIG. 7 is a sectional view showing a closed state of the mold for compression-molding electronic components according to the sixth embodiment of the present invention.

### DESCRIPTION OF THE PREFERRED EMBODIMENTS

### First Embodiment

A mold 1 for compression-molding electronic components, referred to as a cavity-containing spring system, according to a first embodiment of the present invention is now described.

(Structure of Mold for Compression-Molding Electronic Components)

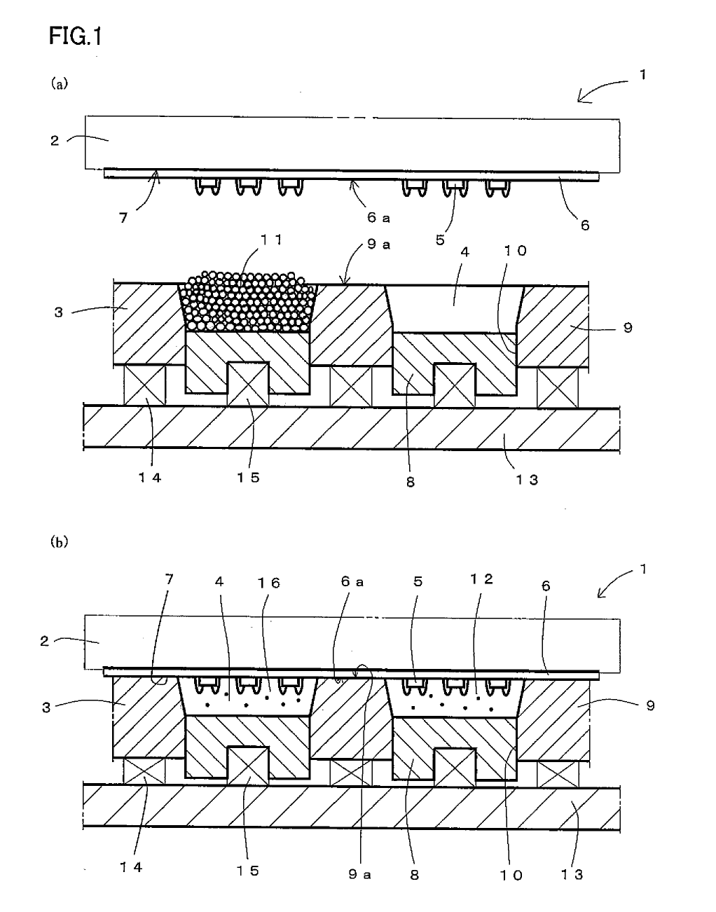

As shown in FIGS. 1(a) and 1(b), mold 1 for compression-molding electronic components according to the first embodiment comprises an upper mold section 2 and a lower mold section 2. Upper mold section 2 and lower mold section 3 are opposed to each other, while upper mold section 2 is fixed and lower mold section 3 is rendered movable. Upper mold section 2 is provided with a substrate supply portion 7 for setting a substrate 6 mounted with electronic components 5 such as semiconductor chips or ICs while directing a surface 6a mounted with electronic components 5 downward.

On the other hand, lower mold section 3 is provided with a prescribed number of cavities 4 for compression molding. Cavities 4 are provided with cavity bottom surface members 8 forming the bottoms of cavities 4. Cavity bottom surface members 8 are vertically slidable in sliding holes 10 provided on lower mold section 3 as movable cavities, in order to pressurize and compression-mold a resin material heated and melted in cavities 4.

Cavity side surface members 9 for clamping the forward end of substrate 6 are provided on the side surfaces of cavities 4 as frame clamps. Substrate 6 set on substrate supply portion 7 of upper mold section 2 is held between upper mold section 2 and lower mold section 3, so that the surface thereof is in contact with forward end surfaces 9a of cavity side surface members 9.

Mold 1 is further provided with a resin material supply portion (not shown) supplying a granular resin material 11, for example, into cavities 4 and a heating portion (not shown) heating resin material 11 supplied into cavities 4 to a necessary molding temperature.

In mold 1, six electronic components 5 mounted on substrate 6 are divided into two sets, so that sets of electronic components 5 are compression-molded (sealed) in resin-molded bodies 12 corresponding to the shapes of respective cavities 4.

(Structure of Resin Pressurization Etc. in Mold)

A pressurizing member (first pressurizing member) 13 is arranged under lower mol section 3 to be opposed to lower mold section 3, for simultaneously pressurizing cavity bottom surface members 8 and cavity side surface members 9. A pressurizing/driving portion (not shown) is further provided for pressurizing/driving pressurizing member 13 toward upper mold section 2 with prescribed pressurizing/driving force. The driving source may alternatively be formed by a mold clamping pressure portion or the like capable of applying prescribed mold clamping pressure to pressurizing member 13.

First elastic members 14 such as compression springs having prescribed elasticity are provided between pressurizing member 13 and the respective ones of cavity side surface members 9. Thus, the prescribed pressurizing/driving force of the pressurizing/driving portion is uniformly and individually transmitted to the respective ones of cavity side surface members 9 through pressurizing member 13 and the respective ones of first elastic members 14.

The pressurizing/driving portion pressurizes/drives pressurizing member 13 upward with the prescribed pressurizing/driving force, so that forward end surfaces 9a of cavity side surface members 9 come into contact with surface 6a of substrate 6 set on substrate supply portion 7 of upper mold section 2 and substrate 6 is held between the mold surfaces of upper mold section 2 and lower mold section 3.

Second elastic members 15 such as compression springs having prescribed elastic force are provided between pressurizing member 13 and the respective ones of cavity bottom surface members 8. Thus, the prescribed pressurizing/driving force of the pressurizing/driving portion is uniformly and individually transmitted to the respective ones of cavity bottom surface members 8 through pressurizing member 13 and the respective ones of second elastic members 15, similarly to the case of cavity side surface members 9. Therefore, a resin material 16 heated and melted in respective cavities 4 can be pressed with prescribed pressure.

After a lapse of a prescribed time necessary for curing resin material 16, sets of electronic components 5 mounted on substrate 1 are compression-molded in resin-molded bodies 12 corresponding to the shapes of respective cavities 4.

(Function of Uniformly Pressurizing Resin)

The pressurizing/driving portion pressurizes/drives single pressurizing member 13 with the prescribed pressurizing/driving force, so that this prescribed pressurizing/driving force is transmitted to the respective ones of second elastic members 15 having the same elastic coefficient and the respective ones of cavity bottom surface members 8 are uniformly urged toward upper mold section 2. Thus, resin material 16 heated and melted in respective cavities 4 can be uniformly and individually pressurized with the prescribed pressure.

(Method of Compression-Molding Electronic Components)

As shown in FIG. 1(a), single substrate 6 mounted with electronic components 5 is first set on substrate supply portion 7 of upper mold section 2 of mold 1, while directing surface 6a mounted with electronic components 5 downward. Then, granular resin material 11, for example, is supplied into the respective ones of prescribed number of cavities 4 provided on lower mold section 3. Then, resin material 11 is heated and melted in cavities 4.

Then, upper mold section 2 and lower mold section 3 are closed with the prescribed mold clamping pressure, for dipping sets of electronic components 5 mounted on substrate 6 into resin material 16 melted in cavities 4, as shown in FIG. 1(b). Then, the pressurizing/driving portion pressurizes/drives pressurizing member 13 toward upper mold section 2 with the prescribed pressurizing/driving force, so that the pressurizing/driving force is transmitted to first elastic members 14 and second elastic members 15 respectively.

The pressurizing/driving force is so transmitted to first elastic members 14 that the same is also transmitted to cavity side surface members 9 and forward end surfaces 9a of cavity side surface members 9 come into contact with surface 6a of substrate 6 set on substrate supply portion 7 of upper mold section 2 with the prescribed pressure.

Further, the pressurizing/driving force is so transmitted to second elastic members 15 that the same is uniformly transmitted to the respective ones of cavity bottom surface members 8 and resin material 16 heated and melted in respective cavities 4 can be uniformly and individually pressurized with the prescribed pressure.

After a lapse of the prescribed time necessary for curing resin material 16, sets of electronic components 5 mounted on substrate 1 are compression-molded in resin-molded bodies 12 corresponding to the shapes of respective cavities 4.

According to aforementioned mold 1 for compression-molding electronic components, second elastic members 15 are so provided between pressurizing member 13 and the respective ones of cavity bottom surface members 8 that the prescribed pressurizing/driving force of the pressurizing/driving portion is uniformly and individually transmitted to the respective ones of cavity bottom surface members 8 through pressurizing member 13 and the respective ones of second elastic members 15. Thus, resin material 16 heated and melted in respective cavities 4 can be uniformly and individually compression-molded with the prescribed pressure, for sealing sets of electronic components 5 mounted on substrate 1.

### Second Embodiment

A mold 21 for compression-molding electronic components, referred to as a chase-containing spring system, according to a second embodiment of the present invention is now described.

(Structure of Mold for Compression-Molding Electronic Components)

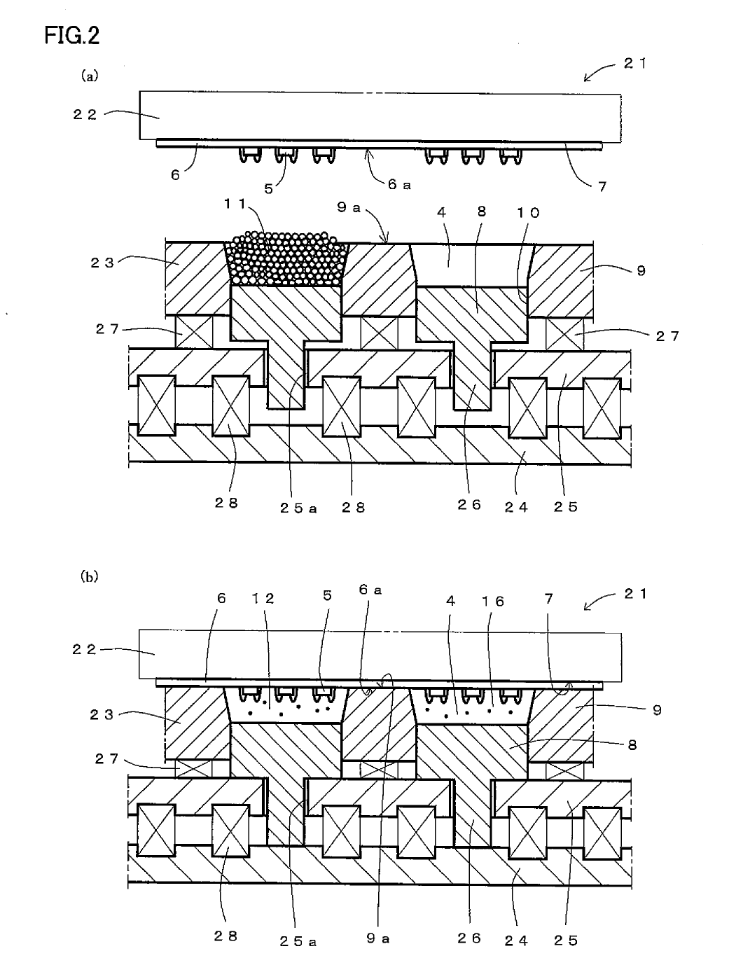

As shown in FIGS. 2(a) and 1(b), mold 21 for compression-molding electronic components according to the second embodiment comprises an upper mold section 22 and lower mold section 23, similarly to mold 1 according to the first embodiment. Upper mold section 22 is provided with a substrate supply portion 7. Lower mold section 23 is provided with cavities 4, cavity side surface members 9 and cavity bottom surface members 8. Cavity bottom surface members 8 are vertically slidable in sliding holes 10 provided on lower mold section 23, and stopped on prescribed positions of lower mold section 23 before compressing a resin material.

A first pressurizing member 24 is arranged under lower mol section 23 of mold 21 to be opposed to lower mold section 23 for pressurizing cavity bottom surface members 8 and cavity side surface members 9, similarly to mold 1 according to the first embodiment. A pressurizing/driving portion (not shown) is further provided for pressurizing/driving first pressurizing member 24 toward upper mold section 22 with prescribed pressurizing/driving force.

(Structure of Resin Pressurization Etc. and Uniform Pressurizing Function)

Mold 21 is further provided with a second pressurizing member 25 between first pressurizing member 24 and cavity bottom surface members 8. Second pressurizing member 25 is provided with through-holes 25a. Pressure receiving portions 26 provided on lower portions of cavity bottom surface members 8 are inserted into through-holes 25a to be vertically movable in a free-fit or sliding mode. Second pressurizing member 25 can pressurize cavity bottom surface members 8 toward upper mold section 22.

First elastic members 27 such as compression springs having prescribed elasticity are provided between cavity side surface members 9 and second pressurizing member 25. Second elastic members 28 such as compression springs having prescribed elasticity are provided between first pressurizing member 24 and second pressurizing member 25.

The pressurizing/driving portion so pressurizes/drives first pressurizing member 24 upward that second pressurizing member 25 can be pressurized toward upper mold section 22 through second elastic members 28. Further, second pressurizing member 25 pressurized toward upper mold second 22 can pressurize cavity side surface members 9 toward upper mold section 22 through first elastic members 27.

Cavity side surface members 9 are so pressurized that forward end surfaces 9a thereof can come into contact with a surface 6a of a substrate 6 set on substrate supply portion 7 of upper mold section 22 before the resin material supplied into cavities 4 is pressurized.

After cavity side surface members 9 come into contact with substrate 6, the prescribed pressurizing/driving force of the pressurizing/driving portion is uniformly and individually transmitted to the respective ones of pressure receiving portions 26 of cavity bottom surface members 8 through first pressurizing member 24, second elastic members 28 and second pressurizing member 25. Therefore, a resin material 16 heated and melted in respective cavities 4 can be uniformly and individually pressurized with prescribed pressure. Thus, single first pressurizing member 24 can uniformly and individually pressurize the respective ones of pressure receiving portions 26 of plurality of cavity bottom surface members 8.

Further, mold 21 according to the second embodiment is so provided with second pressurizing member 25 serving as an auxiliary plate that plurality of second elastic members 28 such as compression springs can be provided between second pressurizing member 25 and first pressurizing member 24. Thus, plurality of second elastic members 28 can efficiently pressurize resin material 16 in cavities 4 with higher pressure, also when cavities 4 are relatively small.

(Method of Compression-Molding Electronic Components)

The compression-molding method with mold 21 according to the second embodiment is basically identical to the compression-molding method with mold 1 according to the first embodiment, and hence points different from those of the first embodiment are mainly described.

As shown in FIG. 2(a), a granular resin material 11 is supplied into cavities 4. Then, resin material 11 is heated and melted in cavities 4. Then, upper mold section 22 and lower mold section 23 are closed for dipping sets of electronic components 5 mounted on substrate 6 into resin material 16 melted in cavities 4, as shown in FIG. 2(b).

Then, the pressurizing/driving portion pressurizes/drives first pressurizing member 24 toward upper mold section 22 with the prescribed pressurizing/driving force, so that this pressurizing/driving force is transmitted to second pressurizing member 25 through second elastic members 28. The pressurizing/driving force transmitted to second pressurizing member 25 is transmitted to the respective ones of cavity side surface members 9 through first elastic members 27, so that forward end surfaces 9a of cavity side surface members 9 come into contact with surface 6a of substrate 6 set on substrate supply portion 7 of upper mold section 22 with the prescribed pressure.

Further, the pressurizing/driving force transmitted to second pressurizing member 25 is uniformly transmitted to the respective ones of cavity bottom surface members 8 through pressure receiving portions 26, so that resin material 16 heated and melted in respective cavities 4 can be uniformly and individually pressurized with the prescribed pressure.

After a lapse of a prescribed time necessary for curing resin material 16, sets of electronic components 5 mounted on substrate 1 are sealed in resin-molded bodies 12 compression-molded into the shapes of cavities 4.

According to aforementioned mold 21 for compression-molding electronic components, second pressurizing member 25 is so provided as an auxiliary plate between lower mold section 23 and first pressurizing member 24 that plurality of second elastic members 28 such as compression springs can be provided between second pressurizing member 25 and first pressurizing member 24. Thus, plurality of second elastic members 28 can uniformly pressurize resin material 16 in respective cavities 4 with higher pressure. Further, single first pressurizing member 24 can uniformly and individually pressurize the respective ones of pressure receiving portions 26 of plurality of cavity bottom surface members 8.

### Third Embodiment

A mold 31 for compression-molding electronic components, referred to as a transfer spring system, according to a third embodiment of the present invention is now described.

(Structure of Mold for Compression-Molding Electronic Components)

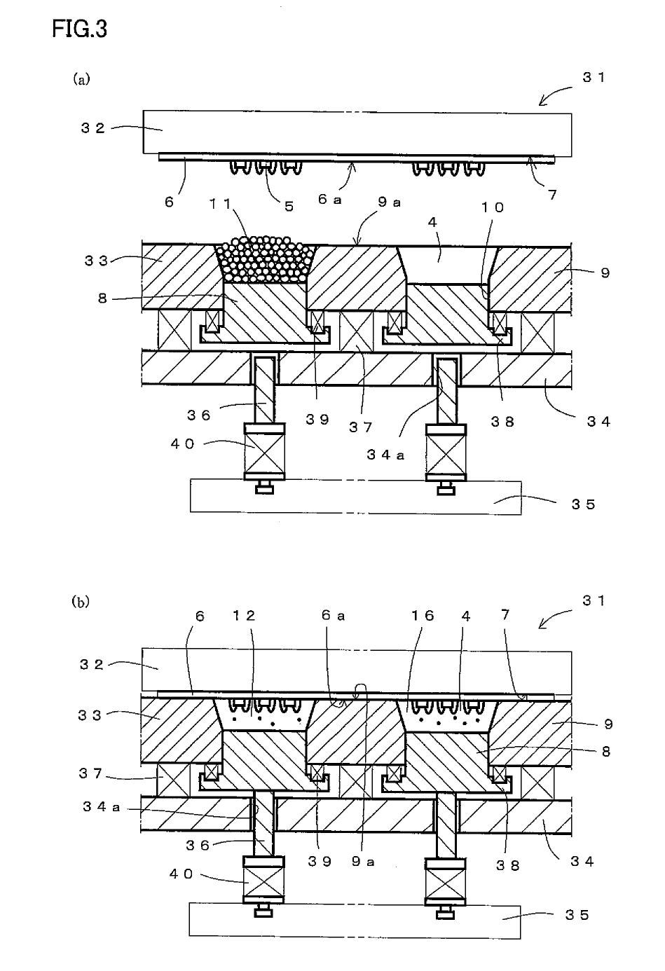

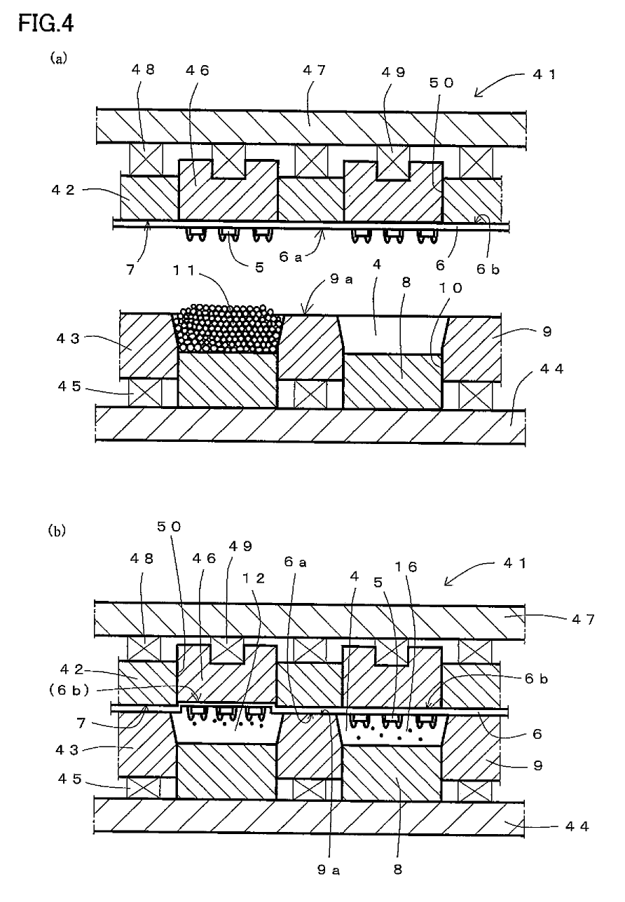

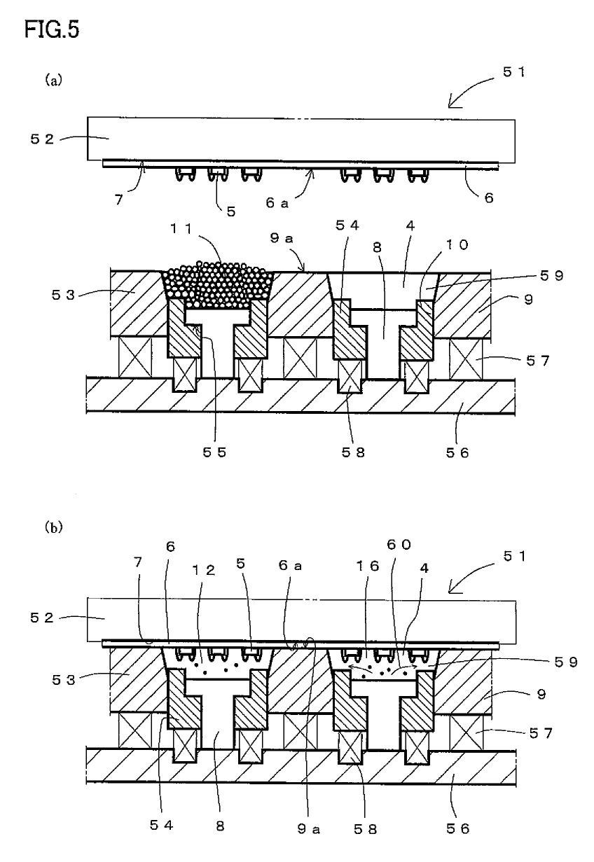

As shown in FIGS. 3(a) and 3(b), mold 31 for compression-molding electronic components according to the third embodiment comprises an upper mold section 32 and lower mold section 33, similarly to mold 1 according to the first embodiment. Upper mold section 32 is provided with a substrate supply portion 7. Lower mold section 33 is provided with cavities 4, cavity side surface members 9 and cavity bottom surface members 8. Cavity bottom surface members 8 are vertically slidable in sliding holes 10 provided on lower mold section 33.

A first pressurizing member 34 (head pressurizing member) is provided under lower mold section 33 of mold 31, in a state separated from cavity side surface members 9 and cavity bottom surface members 8. A first pressurizing/driving portion (not shown) is provided for pressurizing/driving first pressurizing member 34 toward upper mold section 32 with prescribed pressurizing/driving force.

Further, a second pressurizing member 35 is provided under first pressurizing member 34. A second pressurizing/driving portion (not shown) is provided for pressurizing/driving second pressurizing member 35 toward upper mold section 32 with prescribed pressurizing/driving force.

First pressurizing member 34 is provided with through-holes 34a. Transfer portions 36 pressurizing cavity bottom surface members 8 toward upper mold section 32 with prescribed pressure are inserted into through-holes 34 to be vertically movable in a free-fit mode. Transfer portions 36 are provided with third elastic members 40.

(Structure of Resin Pressurization etc. and Uniform Pressurizing Function)

First elastic members 37 such as compression springs having prescribed elasticity are provided between cavity side surface members 9 and first pressurizing member 34.

The first pressurizing/driving portion so pressurizes/drives first pressurizing member 34 upward that cavity side surface members 9 can be pressurized toward upper mold section 32 with the prescribed pressure through first elastic members 37.

Cavity side surface members 9 are so pressurized that forward end surfaces 9a thereof can come into contact with a surface 6a of a substrate 6 set on substrate supply portion 7 of upper mold section 32 before a resin material supplied into cavities 4 is pressurized.

Flange portions 38 extending sideward are provided on lower portions of cavity bottom surface members 8. Second elastic members 39 such as compression springs having prescribed elasticity are provided between flange portions 38 and cavity side surface members 9. Thus, transfer portions 36 are so pressurized toward upper mold section 32 that cavity side surface members 9 can be pressurized upward with the prescribed pressure through second elastic members 39.

While cavity bottom surface members 8 and first pressurizing member 34 are separated from each other at this time as shown in FIG. 3(b), first pressurizing member 34 may alternatively directly pressurize cavity bottom surface members 8. In this case, both of first and second elastic members 37 and 39 can pressurize cavity side surface members 9 upward with the prescribed pressure.

Transfer portions 36 are provided with third elastic members 40 such as compression springs having prescribed elasticity. Lower portions of respective third elastic members 40 are individually fixed to second pressurizing member 35.

Second pressurizing member 35 is pressurized/driven toward upper mold section 32 with the prescribed pressurizing/driving force, so that this pressurizing/driving force is uniformly transmitted to respective cavity bottom surface members 8 through third elastic members 40 and transfer portions 36. Thus, a resin material 16 melted in respective cavities 4 can be uniformly and individually pressurized.

In mold 31 according to the third embodiment, transfer portions 36 and third elastic members 40 pressurizing/driving individual cavity bottom surface members 8 are provided as external elastic units. Thus, the structure of mold 31 can be so simplified that mold 31 (chase unit) can be provided independently of the external elastic units as a general-purpose mold.

(Method of Compression-Molding Electronic Components)

The compression-molding method with mold 31 according to the third embodiment is basically identical to the compression-molding method with mold 1 according to the first embodiment, and hence points different from those of the first embodiment are mainly described.

As shown in FIG. 3(a), a granular resin material 11 is supplied into cavities 4, heated and melted in cavities 4. Then, upper mold section 32 and lower mold section 33 are closed for dipping sets of electronic components 5 mounted on substrate 6 into resin material 16 melted in cavities 4, as shown in FIG. 3(b).

At this time, first pressurizing member 34 is pressurized/driven toward upper mold section 32 with the prescribed pressurizing/driving force, so that this pressurizing/driving force is transmitted to the respective ones of cavity side surface members 9 through first elastic members 37 and forward end surfaces 9a of cavity side surface members 9 can come into contact with surface 6a of substrate 6 set on substrate supply portion 7 of upper mold section 32 with the prescribed pressure.

Further, second pressurizing member 35 is pressurized/driven toward upper mold section 32 with the prescribed pressurizing/driving force, so that this pressurizing/driving force is uniformly transmitted to the respective ones of cavity bottom surface members 8 through transfer portions 36 including third elastic members 40 and resin material 16 heated and melted in respective cavities 4 can be uniformly and individually pressurized with the prescribed pressure.

After a lapse of a prescribed time necessary for curing resin material 16, sets of electronic components 5 mounted on substrate 1 can be sealed in resin-molded bodies 12 compression-molded into the shapes of respective cavities 4.

### Fourth Embodiment

A mold 41 for compression-molding electronic components, referred to as an upper cavity-armored spring system, according to a fourth embodiment of the present invention is now described.

(Structure of Mold for Compression-Molding Electronic Components)

As shown in FIGS. 4(a) and 4(b), mold 41 for compression-molding electronic components according to the fourth embodiment comprises an upper mold section 42 and a lower mold section 43, similarly to mold 1 according to the first embodiment. Upper mold section 42 is provided with a substrate supply portion 7. Lower mold section 43 is provided with cavities 4, cavity side surface members 9 and cavity bottom surface members 8. Cavity bottom surface members 8 are vertically slidable in sliding holes 10 provided on lower mold section 43.

A first pressurizing member 44 is provided under lower mold section 43 of mold 41. Further, a first pressurizing/driving portion (not shown) is provided for pressurizing/driving first pressurizing member 44 toward upper mold section 42.

First elastic members 45 such as compression springs having prescribed elasticity are provided between cavity side surface members 9 and first pressurizing member 44.

(Structure of Resin Pressurization etc. and Uniform Pressurizing Function)

Substrate pressing members 46 pressing a substrate 6 set on substrate supply portion 7 toward lower mold section 43 are provided on portions of upper mold section 42 opposed to cavities 4, to be vertically slidable. A second pressurizing member 47 pressurizing/driving substrate pressing members 46 is provided above upper mold section 42. A second pressurizing/driving portion (not shown) is provided for pressurizing/driving second pressurizing member 47 toward lower mold section 43 with prescribed pressurizing/driving force.

Second elastic members 48 such as compression springs having prescribed elasticity are provided between second pressurizing member 47 and upper mold section 42. Further, third elastic members 49 such as compression springs having prescribed elasticity are provided between second pressurizing member 47 and substrate pressing members 46.

The second pressurizing/driving portion so pressurizes/drives second pressurizing member 47 downward that upper mold section 42 can be pressurized toward lower mold section 43 with the prescribed pressure through second elastic members 48.

Further, the second pressurizing/driving portion so pressurizes/drives second pressurizing member 47 downward that the pressurizing/driving force is uniformly transmitted to the respective ones of substrate pressing members 46 through third elastic members 49. Thus, portions of a back surface 6b of substrate 6 opposed to cavities 4 are pressurized toward cavities 4 with the prescribed pressure, so that a resin material 16 melted in cavities 4 can be uniformly and individually pressurized (upper cavity-armored spring system).

The first and second pressurizing/driving portions may be replaced with mold clamping pressure portions capable of applying prescribed mold clamping pressure to first pressurizing member 44 and second pressurizing member 47 respectively as driving sources.

(Method of Compression-Molding Electronic Components)

The compression-molding method with mold 41 according to the fourth embodiment is basically identical to the compression-molding method with mold 1 according to the first embodiment, and hence points different from those of the first embodiment are mainly described.

As shown in FIG. 4(a), a granular resin material 11 is supplied into cavities 4, heated and melted in cavities 4. Then, upper mold section 42 and lower mold section 43 are closed for dipping sets of electronic components 5 mounted on substrate 6 into resin material 16 melted in cavities 4, as shown in FIG. 4(b).

At this time, first pressurizing member 44 is pressurized/driven toward upper mold section 42 with the prescribed pressurizing/driving force, so that this pressurizing/driving force is transmitted to the respective ones of cavity side surface members 9 through first elastic members 45 and forward end surfaces 9a of cavity side surface members 9 can come into contact with a surface 6a of substrate 6 set on substrate supply portion 7 of upper mold section 42.

Further, second pressurizing member 47 is pressurized/driven toward lower mold section 43 with the prescribed pressurizing/driving force, so that this pressurizing/driving force is transmitted to upper mold section 42 through second elastic members 48 and upper mold section 42 can be pressed with the prescribed pressure. Thus, substrate 6 is held between the mold surfaces of upper and lower mold sections 42 and 43.

In addition, first pressurizing member 44 is pressurized/driven with the prescribed pressurizing/driving force, so that this pressurizing/driving force is transmitted to the respective ones of cavity bottom surface members 8 and resin material 16 heated and melted in respective cavities 4 can be uniformly and individually pressurized with the prescribed pressure.

Second pressurizing member 47 is driven with the prescribed pressurizing/driving force, so that this pressurizing/driving force is transmitted to substrate pressing members 46 through third elastic members 49 and portions of substrate 6 opposed to cavities 4 are pressurized toward cavities 4 with the prescribed pressure and resin material 16 melted in cavities 4 can be uniformly and individually pressurized.

Thus, resin material 16 heated and melted in respective cavities 4 can be uniformly and individually pressurized by cavity bottom surface members 8 of lower mold section 43 and the portions of substrate 6 set on upper mold section 42.

(Other Structure of Mold)

While mold 41 of the upper cavity-armored spring system has been described with reference to the fourth embodiment, a mold of an upper cavity-containing spring system may alternatively be employed in place of mold 41 of the upper cavity-armored spring system.

In the mold of the upper cavity-containing spring system, substrate pressing members 46 corresponding to openings of cavities 4 are not pressurized/driven by second pressurizing member 47 through third elastic members 49, but rendered vertically movable by fourth elastic members (not shown), having prescribed elasticity, provided in upper mold section 42 in mold 41 of the upper cavity-armored spring system (see FIGS. 4(a) and 4(b)).

In this mold of the upper cavity-containing spring system, substrate pressing members 46 can be uniformly and individually pressurized against substrate 6 due to prescribed pressure of the fourth elastic members contained therein. Thus, resin material 16 heated and melted in respective cavities 4 can be uniformly pressurized by cavity bottom surface members 8 of lower mold section 43 and the portions of substrate 6 set on upper mold section 42 similarly to mold 41 of the upper cavity-armored spring system, to be compression-molded.

If a thin substrate such as a soft filmy substrate, for example, is set as substrate 6 and the quantity of resin material 11 supplied into cavities 4 is dispersed in mold 41 according to the fourth embodiment, the pressure applied to resin material 11 in cavities 4 is bypassed.

If excessive pressure is applied to resin material 1 as in left cavity 4 shown in FIG. 4(b), corresponding substrate pressing member 46 inserted into a sliding hole 50 of upper mold section 42 moves upward. Thus, substrate 6 enters sliding hole 50 due to the movement of substrate pressing member 46 to increase the volume of cavity 4, so that the pressure applied to resin material 11 can be bypassed. When electronic components 5 mounted on filmy substrate 6 are sealed with resin material 16, therefore, resin material 16 heated and melted in respective cavities 4 can be uniformly and individually pressurized by cavity bottom surface members 8 of lower mold section 43 and the portions of thin substrate 6 set on upper mold section 42.

### Fifth Embodiment

A mold 51 for compression-molding electronic components, referred to as a flow cavity system, according to a fifth embodiment of the present invention is now described.

(Structure of Mold for Compression-Molding Electronic Components)

As shown in FIGS. 5(a) and 5(b), mold 51 for compression-molding electronic components according to the fifth embodiment comprises an upper mold section 52 and a lower mold section 53, similarly to mold 1 according to the first embodiment. Upper mold section 52 is provided with a substrate supply portion 7. Lower mold section 53 is provided with cavities 4, cavity side surface members 9 and cavity bottom surface members 8. Cavity bottom surface members 8 are vertically slidable in sliding holes 10 provided on lower mold section 53.

Lower mold section 53 is further provided with resin pressurizing members 54 in addition to cavity bottom surface members 8, in order to press a resin material 16 in cavities 4. Cavity bottom surface members 8 are arranged at the centers of cavities 4, while resin pressurizing members 54 are arranged on both sides of cavity bottom surface members 8 respectively. Cavity bottom surface members 8 and resin pressurizing members 54 are individually vertically slidable in sliding holes 10 provided on lower mold section 53.

Resin material 16 melted in cavities 4 can be first pressurized by cavity bottom surface members 8, and then pressurized by resin pressurizing members 54. Resin pressurizing members 54 pressurizing resin material 16 in cavities 4 are stopped by stop portions 55 provided on cavity bottom surface members 8.

If the quantity of a resin material 11 supplied into cavities 4 is insufficient, therefore, resin material 16 melted in cavities 4 can be pressurized in an auxiliary manner by pressurizing/driving resin pressurizing members 54 upward to protrude from the bottom surfaces of cavity bottom surface members 8. Thus, melted resin material 16 can be efficiently pressurized.

(Structure of Resin Pressurization Etc. and Uniform Pressurizing Function)

As shown in FIGS. 5(a) and 5(b), a pressurizing member 56 is provided under lower mold section 53. Further, a pressurizing/driving portion (not shown) is provided for pressurizing/driving pressurizing member 56 toward upper mold section 52. A mold clamping pressure portion capable of applying prescribed mold clamping pressure to pressurizing member 56 may alternatively be employed as a driving source, in place of the pressurizing/driving portion.

First elastic members 57 such as compression springs having prescribed elasticity are provided between pressurizing member 56 and cavity side surface members 9. Pressurizing member 56 is so pressurized/driven upward that cavity side surface members 9 can be pressurized toward upper mold section 52 with prescribed pressure through first elastic members 57.

Cavity side surface members 9 are so pressurized that forward end surfaces 9a thereof can come into contact with a surface 6a of a substrate 6 set on substrate supply portion 7 of upper mold section 52 before a resin material 11 supplied into cavities 4 is pressurized.

As shown in FIGS. 5(a) and 5(b), respective cavity bottom surface members 8 are fixed to pressurizing member 56. Further, second elastic members 58 such as compression springs having prescribed elasticity are provided between pressurizing member 56 and resin pressurizing members 54. Pressurizing member 56 is pressurized toward upper mold section 52 with prescribed pressurizing/driving force of the pressurizing/driving portion, so that prescribed pressure is first uniformly transmitted to respective cavity bottom surface members 8. Then, the pressurizing/driving force is uniformly transmitted to respective resin pressurizing members 54 through second elastic members 58. Thus, resin material 16 melted in respective cavities 4 can be uniformly and individually pressurized with the prescribed pressure.

Resin material 16 melted in cavities 4 is compression-molded while resin pressurizing members 54 protrude from the bottom surfaces of cavity bottom surface members 8, so that recesses corresponding to protruding resin pressurizing members 54 are formed on resin-molded bodies 12.

In mold 51 according to the fifth embodiment, moving resin pockets 59 are provided in cavities 4 as internal pressure absorbing portions. Thus, dispersion in the thicknesses of resin-molded bodies 12 resulting from excessiveness/insufficiency in the quantity of resin material 11 supplied into cavities 4 can be reduced.

If the quantity of resin material 11 supplied into cavities 4 is insufficient, for example, the thicknesses of resin-molded bodies 12 compression-molded in cavities 4 are easily dispersed. In mold 51 according to the fifth embodiment, such insufficiency in the quantity of resin material 11 can be controlled by protruding resin pressurizing members 54 provided on the sides of cavity bottom surface members 8 into cavities 4 of lower mold section 53.

In this case, resin material 16 melted in cavities 4 flows from the centers to side portions on the bottom surfaces of cavities 4 as shown by arrows 60, to flow into moving resin pockets 59 (spaces) above resin pressurizing members 54.

If the quantity of resin material 11 is insufficient, resin material 16 flowing into moving resin pockets 59 (spaces) is pressurized upward by cavity bottom surface members 8 with the prescribed pressure, and the forward ends of resin pressurizing members 54 are protruded upward into cavities 4 with the prescribed pressure.

Thus, if the quantity of resin material 11 is insufficient or the number of electronic components 5 is smaller than a prescribed number, dispersion in the thicknesses of resin-molded bodies 12 can be reduced by preventing reduction of the thicknesses below a prescribed thickness by controlling the quantity of protrusion of resin pressurizing members 54 in cavities 4. Further, the pressure applied to resin material 16 melted in cavities 4 can be efficiently controlled by resin pressurizing members 54.

If an excessive quantity of resin material 11 is supplied into cavities 4 or the number of electronic components 5 is larger than the prescribed number, on the other hand, dispersion in the thicknesses of resin-molded bodies 12 can be reduced by preventing increase of the thicknesses beyond the prescribed thickness by pressing resin material 16 flowing into moving resin pockets 59 (spaces) with the prescribed pressure while locating the forward end surfaces of resin pressurizing members 54 below those of cavity bottom surface members 8.

(Method of Compression-Molding Electronic Components)

The compression-molding method with mold 51 according to the fifth embodiment is basically identical to the compression-molding method with mold 1 according to the first embodiment, and hence points different from those of the first embodiment are mainly described.

As shown in FIG. 5(a), granular resin material 11 is supplied into cavities 4, heated and melted in cavities 4. Then, upper mold section 52 and lower mold section 53 are closed for dipping sets of electronic components 5 mounted on substrate 6 into resin material 16 melted in cavities 4, as shown in FIG. 5(b).

At this time, pressurizing member 56 is pressurized/driven toward upper mold section 52 with the prescribed pressurizing/driving force, so that this pressurizing/driving force is transmitted to the respective ones of cavity side surface members 9 through first elastic members 57 and forward end surfaces 9a of cavity side surface members 9 can come into contact with surface 6a of substrate 6 set on substrate supply portion 7 of upper mold section 52.

Then, pressurizing member 56 is pressurized toward upper mold section 52 with the prescribed pressurizing/driving force of the pressurizing/driving portion, so that the prescribed pressure is first uniformly transmitted to respective cavity bottom surface members 8. Then, the pressurizing/driving force is uniformly transmitted to respective resin pressurizing members 54 through second elastic members 58 in an auxiliary manner. Thus, resin material 16 melted in respective cavities 4 can be uniformly and individually pressurized with the prescribed pressure.

Thus, resin material 16 heated and melted in cavities 4 can be uniformly and individually pressurized with the prescribed pressure by cavity bottom surface members 8 including resin pressurizing members 54.

### Sixth Embodiment

A mold 61 for compression-molding electronic components according to a sixth embodiment of the present invention is now described. The basic structure of mold 61 according to the sixth embodiment is substantially identical to those of molds 1 to 51 according to the first to fifth embodiments, and a resin material melted in cavities can be uniformly and individually pressurized by transmitting prescribed pressurizing/driving force to cavity bottom surface members through elastic members.

(Structure of Mold for Compression-Molding Electronic Components)

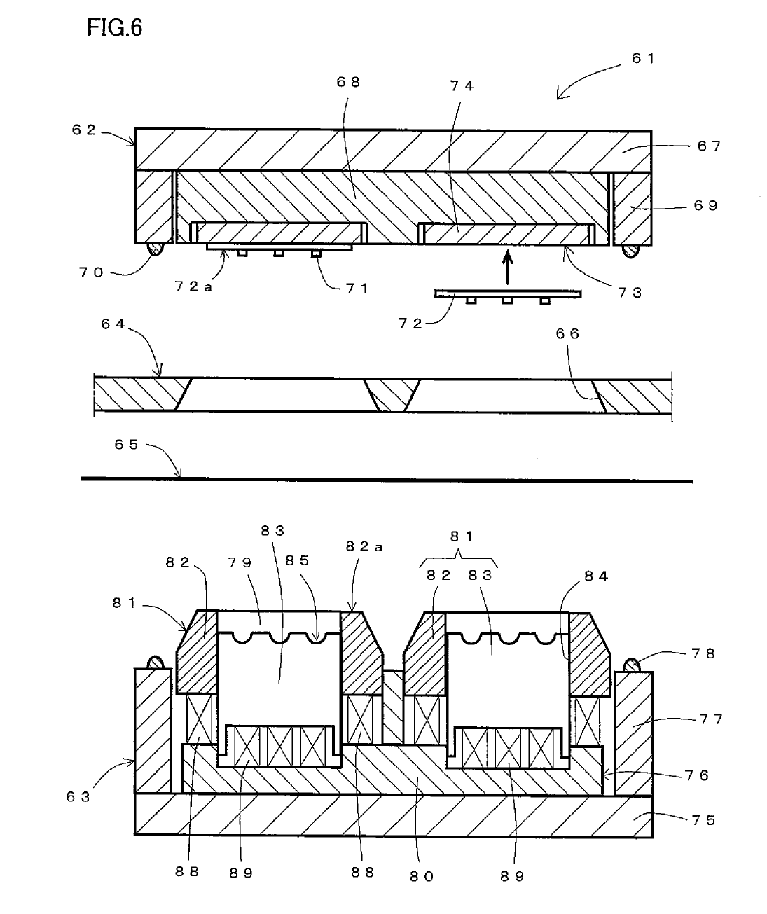

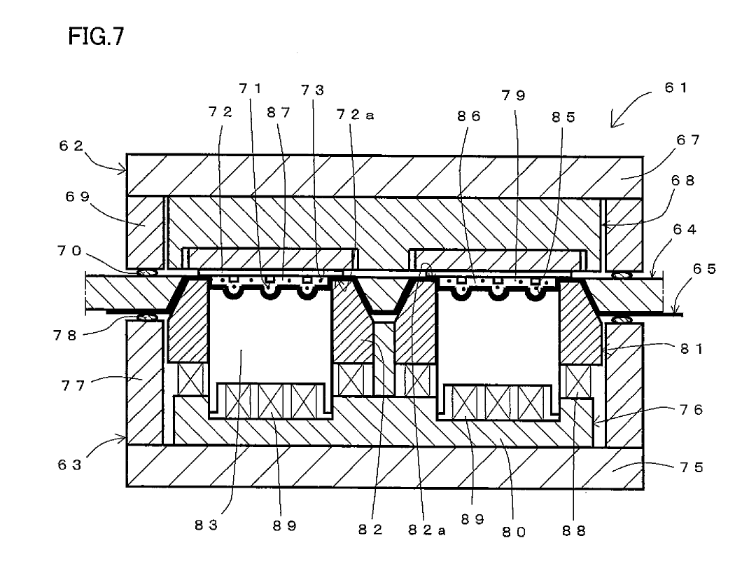

As shown in FIGS. 6 and 7, mold 61 for compression-molding electronic components according to the sixth embodiment, referred to as a three-plate mold, comprises an upper mold section 62, a lower mold section 63 and an intermediate plate 64. Upper and lower mold sections 62 and 63 are opposed to each other, while upper mold section 62 is fixed. Intermediate plate 64 is arranged between upper and lower mold sections 62 and 63. Intermediate plate 64 is provided with receiving holes 66 receiving cavity members 81 provided on lower mold section 63 in a free-fit mode. A mold releasing film 65 is arranged between intermediate plate 64 and lower mold section 63.

Upper mold section 62 includes an upper base 67, an upper chase 68, an upper internal air isolation member 69 and a sealing member 70. Upper chase 68 is provided on the lower surface of upper base 67. Internal air isolation member 69 is provided on the periphery of upper chase 68. Sealing member 70 such as an O-ring is provided on the lower end surface of upper internal air isolation member 69.

Upper chase 67 is provided with substrate supply portions 73 for setting substrates 72 mounted with electronic components 71 such as LED (light-emitting diode) chips while directing surfaces 72a mounted with electronic components 71. Substrate supply portions 73 are provided with electronic component position control portions 74 for setting electronic components 71 mounted on substrates 72 on prescribed positions with respect to cavities.

On the other hand, lower mold section 63 includes a lower base 75, a lower chase 76, a lower internal air isolation member 77 and a sealing member 78. Lower chase 76 is provided on the upper surface of lower base 75. Lower internal air isolation member 77 is provided on the periphery of lower chase 76. Sealing member 78 such as an O-ring is provided on the upper end surface of lower internal air isolation member 77.

Lower chase 76 is provided with a lower chase holder 80 and cavity members 81. A prescribed number of cavity members 81 are provided with respect to lower chase holder 80. Respective ones of cavity members 81 include cavity side surface members 82 and cavity bottom surface members 83. Cavity side surface members 82 form side surfaces of large cavities 79, while cavity bottom surface members 83 form bottom surfaces of large cavities 79. Cavity bottom surface members 83 are vertically slidable in sliding holes 84 provided on cavity members 81. Cavity bottom surface members 83 forming the bottom surfaces of large cavities 79 have planar upper surfaces, while semicircular recesses are formed on prescribed positions corresponding to electronic components 71 as small cavities 85.

Mold 61 is further provided with adsorbing/covering portions (not shown) for applying mold releasing film 65 in response to the shapes of large and small cavities 79 and 85, a resin material supply portion (not shown) such as a lateral dispenser supplying a prescribed resin material into cavities 79 covered with mold releasing film 65 and a heating portion (not shown) heating mold 61 to a prescribed molding temperature. A transparent liquid resin material 86 is supplied as the resin material, as described later.

Mold 61 is further provided with a decompression portion (not shown) formed by a vacuum pump or the like forcibly sucking and discharging air from large and small cavities 79 and 85 when mold 61 is closed.

In mold 61 according to the sixth embodiment, the surfaces of large and small cavities 79 and 85 are covered with mold releasing film 65 held between intermediate plate 64 and lower mold section 63, and a prescribed quantity of liquid resin material 86 is supplied into large and small cavities 79 and 85 covered with mold releasing film 65.

On the other hand, substrates 72 mounted with electronic components 71 are individually set on substrate supply portions 73 of upper mold section 62. At this time, electronic component position control portions 74 control the positions of substrates 72 so that the positions of electronic components 71 mounted thereon are in prescribed arrangement relation with respect to small cavities 85.

Then, mold 61 is closed for bringing sealing members 70 and 78 provided on upper and lower internal air isolation members 69 and 77 into contact with intermediate plate 64 and mold releasing film 65 respectively, thereby cutting off the space where large and small cavities 79 and 85 are positioned from the outside air. The space is so cut off from the outside air that the same can be decompressed to a prescribed degree of vacuum by the decompression portion.

Then, cavity bottom surface members 83 are pressurized/driven toward upper mold section 62 with the prescribed pressurizing/driving force, so that liquid resin material 86 heated in large and small cavities 79 and 85 can be pressured with prescribed pressure.

After a lapse of a time necessary for curing resin material 86, electronic components 71 mounted on substrates 72 are sealed in resin-sealed bodies 87 compression-molded into the shapes of large and small cavities 79 and 85. Resin-molded bodies 87 extracted by opening mold 61 are provided with planar surfaces (flat surfaces) corresponding to large cavities 79, while protrusions corresponding to small cavities 85 are formed on these surfaces.

(Structure of Resin Pressurization etc. and Uniform Pressurizing Function)

As shown in FIGS. 6 and 7, first elastic members 88 such as compression springs having prescribed elasticity are provided between cavity side surface members 82 and lower chase holder 80.

Further, second elastic members 89 such as compression springs having prescribed elasticity are provided between cavity bottom surface members 83 and lower chase holder 80.

Lower mold section 63 is provided with a pressurizing/driving portion pressurizing/driving lower chase 68 upward with prescribed pressurizing/driving force. Alternatively, a mold clamping pressure portion closing overall lower mold 63 upward with prescribed mold clamping pressure may be provided.

When mold 61 is closed, the pressurizing/driving portion applies the prescribed pressurizing/driving force to lower chase 68, so that this pressurizing/driving force is transmitted to cavity side surface members 82 through lower chase holder 80 and first elastic members 88. The pressurizing/driving force is so transmitted to cavity side surface members 82 that forward end surfaces 82a thereof can come into contact with surfaces 72a of substrates 72 set on substrate supply portions 83 of upper mold section 62.

When mold 61 is closed, the pressurizing/driving portion further applies the prescribed pressurizing/driving force to lower chase 68, so that this pressurizing/driving force is uniformly transmitted to individual cavity bottom surface members 83 through lower chase holder 80 and second elastic members 89. The pressurizing/driving force is so transmitted to cavity bottom surface members 83 that liquid resin material 86 melted in large and small cavities 79 and 85 can be uniformly and individually pressurized with the prescribed pressure.

(Method of Compression-Molding Electronic Components)

First, large and small cavities 79 and 85 are covered with mold releasing film 65 held between lower mold section 63 and intermediate plate 64. The prescribed quantity of liquid resin material 86 is supplied into large and small cavities 79 and 85 covered with mold releasing film 65. Then, substrates 72 mounted with electronic components 71 are set on substrate supply portions 73 of upper mold section 62. Then) mold 61 is so closed as to dip electronic components 71 mounted on substrates 72 into liquid resin material 86 heated in large and small cavities 79 and 85.

At this time, the pressurizing/driving portion transmits the prescribed pressurizing/driving force to cavity side surface members 82, so that forward end surfaces 82a thereof can come into contact with surfaces 72a of substrates 72 set on substrate supply portions 73 of upper mold section 62 with the prescribed pressure.

Further, the pressurizing/driving portion uniformly transmits the prescribed pressurizing/driving force to bottom surface members 83, so that liquid resin material 86 heated in large and small cavities 79 and 85 can be uniformly and individually pressurized.

In addition, sealing members 70, 78 etc. cut off the space where large and small cavities 79 and 85 are positioned from the outside air, whereby the decompression portion can decompress this space to the prescribed degree of vacuum. Thus, electronic components 71 can be sealed in resin-sealed bodies 87 by compressing liquid resin material 68 without leaving air therein.

While granular or liquid resin material 11 or 86 is employed in each of the aforementioned embodiments, a powder or sheetlike resin material can also be employed. Further, a transparent, semitransparent, opaque, one-part or two-part resin material is also employable.

In addition, the resin material can be prepared from a silicon-based or epoxy-based resin material.

While the mold is provided with two cavities and the plurality of electronic components are sealed in each resin-sealed body in each of the cavities in each of the aforementioned embodiments, the number of the cavities provided on the mold is not restricted to two, but the mold may alternatively comprise at least three cavities. Further, the number of the electronic components sealed in each cavity of the mold is not restricted to two either, but a single electronic component may alternatively be sealed in each resin-molded body.

While the elastic members are formed by compression springs in each of the aforementioned embodiments, the elastic members are not restricted to the compression springs, but may alternatively be formed by proper members such as disc springs or plate springs having elasticity.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of compression-molding electronic components for sealing electronic components by compression-molding a resin material with a prescribed mold, comprising the steps of:
preparing a mold including an upper mold section and a lower mold section opposed to said upper mold section and provided with a plurality of cavities supplied with said resin material as said prescribed mold;
forming a compression-molded body sealing said electronic components by closing said upper mold section and said lower mold section thereby dipping the respective ones of a plurality of electronic components mounted on a substrate held on said upper mold section into said resin material heated and melted in corresponding said cavities while uniformly pressurizing and compressing said resin material melted in the respective ones of said plurality of cavities by resin pressing members provided on the bottom surfaces of the respective ones of said plurality of cavities; and
extracting said substrate mounted with said electronic components sealed in said compression-molded body by opening said upper mold section and said lower mold section.

2. The method of compression-molding electronic components according to claim 1, wherein
the step of forming said compression-molded body includes the step of uniformly pressurizing and compressing said resin material melted in the respective ones of said plurality of cavities by another resin pressing member from a surface of said substrate opposite to the surface mounted with said electronic components.

3. The method of compression-molding electronic components according to claim 1, wherein
said resin material melted in the respective ones of said plurality of cavities is uniformly pressurized and compressed by pressure transmitted through elastic members provided on said resin pressing members in the step of forming said compression-molded body.

4. The method of compression-molding electronic components according to claim 1, further comprising the steps of:
covering said plurality of cavities with a mold releasing film,
supplying said resin material to the respective ones of said plurality of cavities covered with said mold releasing film, and
cutting off the space where said cavities are positioned from the outside air by sealing a clearance between said upper mold section and said lower mold section between the steps of preparing said mold and forming said compression-molded body, wherein
compression molding is performed by decompressing said space, where said cavities are positioned, cut off from the outside air to a prescribed degree of vacuum in the step of forming said compression-molded body.

5. A mold for compression-molding electronic components for sealing electronic components by compression-molding a resin material with an upper mold section and a lower mold section, wherein
said upper mold section includes a substrate supply portion for setting a substrate mounted with said electronic components,
said lower mold section includes:
a plurality of cavities supplied with said resin material respectively; and
a resin pressing member pressurizing said resin material heated and melted in said cavities with prescribed pressure, and
said resin pressing member includes a uniform pressurizing portion uniformly pressurizing said resin material heated and melted in the respective ones of said plurality of cavities.

6. The mold for compression-molding electronic components according to claim 5, wherein
said resin pressing member includes a cavity bottom surface member forming the bottom surfaces of said cavities, and
said uniform pressurizing portion includes an elastic member transmitting said prescribed pressure to said cavity bottom surface member.

7. The mold for compression-molding electronic components according to claim 5, wherein
said resin pressing member includes a cavity bottom surface member forming the bottom surfaces of said cavities, and
said cavity bottom surface member is divided into a prescribed number.
